(19) United States
(12) Patent Application Publication
(10) Pub. No.: US 2024/0092614 A1
(43) Pub. Date: Mar. 21, 2024

(54) GRIPPING ASSEMBLY

(71) Applicant: F.LLI RIGHINI S.R.L., RAVENNA (IT)

(72) Inventors: Renzo RIGHINI, RAVENNA (IT); Franco ARGELLI, RAVENNA (IT)

(21) Appl. No.: 18/038,806

(22) PCT Filed: Nov. 26, 2021
(86) PCT No.: PCT/IB2021/061004

§ 371 Date: May 25, 2023

(30) Foreign Application Priority Data
Nov. 27, 2020 (IT) 102020000028784

(51) Int. Cl. B66C 1/56; B66C 13/08; E02D 13/00

(52) U.S. Cl. CPC B66C 1/56; B66C 13/08; E02D 13/00

(57) ABSTRACT

A gripping assembly (1) designed to grasp cylindrical piles (CP) provided with a longitudinal axis (AL) in an end position: the assembly (1) comprising a first cylindrical body (10) provided with a central axis (CA) and delimited by a first upper flat face (2) and by a second lower flat face (3), parallel to each other and transversal to the central axis (CA) of the same first body (10) and a plurality of gripping members (12) evenly distributed around the central axis (CA) and radially movable to couple with one of the piles (CP) by friction: a lifting arm (20) comprising at least one support portion (22) arranged laterally with respect to a longitudinal diametral plane (M) carried by the first body (10) hinged to a plate (100)(100′) integral with the first body (10) around a first axis (TAI) transversal to the diametral plane: the first axis (TAI) being arranged on the outside of the first body (10) on the side opposite to said second face (3) with respect to the first face (2).

The present invention concerns a gripping assembly. In particular, the present invention refers to a gripping assembly for gripping piles through a respective end portion. In further detail, the present invention refers to a gripping assembly for gripping piles through a respective end portion, where said assembly is designed to move said piles around an axis passing through this end portion.

### DESCRIPTION OF THE STATE OF THE ART

In the handling sector and in particular lifting and verticalization of cylindrical bodies, for example but not limited to steel piles for uses in the offshore energy industry (for example, but not limited to, the oil & gas and wind sectors) it is known to use gripping devices carried by a respective axle associated with a lifting arm coupled in a rotatable manner to a gripping device provided with a plurality of radially movable gripping members to couple by friction with the internal or external shell of the piles to be handled. In each gripping assembly, the arm has an axle that can be gripped in a rotatable manner by a crane. The arm of each assembly is coupled to the gripping device through an axle and a control member for controlling the reciprocal rotation normally comprising at least one linear actuator. The function of the linear actuator is to correctly orient the gripping device in the vertical plane (for example, but not limited to, from vertical to horizontal and vice versa) in order to determine insertion therein of the pile to be lifted or handled. Once the gripping device has been fully inserted and then locked inside the pile, and before commencing the pile lifting and/or verticalization operation, the linear actuator can be made floating, so that the arm can passively follow the orientation of the cylindrical pile throughout the subsequent lifting operation by cables connected to the crane without opposing resistance. In view of the mass, at times considerable, of the piles to be lifted, understood as foundation piles, in some situations it may be difficult for the linear actuator alone to actively control orientation of the arm that carries the gripping device during the operation.

Therefore, also to avoid excessively increasing the power, and therefore also mass and overall dimensions, of the linear actuator, which would negatively affect the performance of the crane used, it is common practice to make the arm “floating” in its rotation plane, so that it can passively follow the orientation of the pile from the beginning right through to the end of the lifting phase, in which the pile lifted can be vertical. In this situation the linear actuator is left loose and, in particular, the relative stem is left free to translate with respect to the corresponding armature so that the distance between the free end of the stem and the free end of the armature can vary freely, and hence the relative angle between the gripping device and the arm, and therefore between the pile and the arm.

An example of said assembly is found in the patent EP 2925658 of IHC, the arm of which is coupled centrally to the gripping device in a diametral axis that crosses it and the relative rotation between the gripping device and the arm is controlled by a lever operated by a linear actuator.

If, as frequently occurs, the configuration of the handled pile has to be vertical at the end of lifting for the subsequent pile driving operation, it would result in the drawback that the handling and final positioning of the pile are less easy for the lifting crane to control due to the presence of the lifting arm interposed between the crane lifting cables and the pile. The main reason for this is that in this phase the arm is in a “floating” configuration, so that the cylindrical body is effectively like the second pendulum of a double-pendulum configuration in which the arm constitutes the first pendulum and the pile, carried integrally by the gripping device, constitutes the second pendulum. In conditions of strong wind and/or very rough sea this could result in very limited controllability of the pile lifted by the cylindrical body, accompanied by great difficulty in positioning the lower end of the pile where required.

Naturally, this circumstance (“floating” arm) could also occur when, due to the wave motion or any unexpected cause, the linear actuator is not able to control the relative angle between the arm and the gripping device due to inadequate dimensions or poor maintenance. In these cases, the arm rotations could be so wide as to cause the arm to impact against the internal walls of the gripping device, which could result in serious damage to the arm and/or to the gripping device.

In view of the situation described above, a gripping assembly would be desirable in which, when the pile to be handled is coaxial with the gripping device that carries it, the condition of coaxiality is maintained even when the linear actuator that regulates the relative inclination of the gripping device with respect to the arm is deactivated. In this way, it is possible to limit and overcome the drawbacks typical of the known art, including the drawback illustrated above, and define a new standard for said types of equipment.

### SUMMARY OF THE PRESENT INVENTION

The present invention concerns a gripping assembly. In particular, the present invention refers to a gripping assembly for gripping piles through a respective end portion. In further detail, the present invention refers to a gripping assembly for gripping piles through a respective end portion, where said assembly is designed to move said piles around an axis passing through said end portion.

The drawbacks illustrated above are solved by the present invention according to at least one of the following claims.

According to one embodiment of the present invention, a gripping assembly is actuated designed to grip the cylindrical piles provided with a longitudinal axis in an end position; said assembly comprising a first cylindrical body provided with a central axis and with a plurality of gripping members evenly distributed around said central axis and radially movable to couple with one of said piles by friction; a lifting arm comprising at least a support portion arranged symmetrically relative to a longitudinal diametral plane carried by said first body hinged to a respective plate integral with said first body around a first axis transversal to said diametral plane; each said support portion being provided with a central axis developed around a fulcrum axis parallel to said first axis for supporting said arm in a rotatable manner; said first axis being parallel to and distinct from a diametral axis of said first body transversal with respect to said diametral plane.

According to an embodiment as described above, each said support portion has an elbow coupled rotoidally with the corresponding said plate around said first axis through a first hooking member; each said plate having a second coupling member coupled with said elbow in an angularly sliding manner through a respective circular slot concentric with said first axis and delimited by two concave abutment portions.

According to an embodiment as described above, said lifting arm comprises two support portions each hinged to a respective said plate around said first axis, said support portions being arranged symmetrically with respect to said diametral plane; said support portions being connected by said central axle.

According to an embodiment as described above, a first projection of a centre of said first hooking member over said diametral plane and a second projection of a centre of said second hooking member over said diametral plane define a segment, a geometric axis of which is parallel to or coincides with said central axis.

According to an embodiment as described above, said two concave abutment portions are spaced from each other by an angle of less than 90° centred on said first axis. According to an embodiment as described above, actuation means are arranged between said arm and said first body to move them with relative rotary motion around said first axis.

According to an embodiment as described above, said actuation means comprise a linear actuator, the axis of which is transversal to said first axis and is carried at the ends by a first bracket coupled with said first body and by a second bracket coupled with said arm in an angularly fixed manner.

According to an embodiment as described above, each said second hooking member comprises a pin carried by a bracket of said plate.

According to an embodiment as described above, said first hooking member comprises a rotoidal pair.

According to an embodiment as described above, said first axis is external or internal to said first body.

### BRIEF DESCRIPTION OF THE FIGURES

Further characteristics and advantages of the gripping assembly according to the present invention will appear clearer from the following description, provided with reference to the attached figures which illustrate at least one non-limiting embodiment example thereof, in which identical or corresponding parts are identified by the same reference numbers. In particular:

FIG. 1 is a schematic perspective view of a gripping assembly according to the present invention;

FIGS. 2-4 are lateral elevation views of the assembly of FIG. 1 in three distinct operating configurations, where some parts have not been illustrated for the sake of clarity.

### DETAILED DISCLOSURE OF THE PRESENT INVENTION

Before describing in detail the preferred embodiments of the present invention or details thereof, it is useful to specify that the relative scope is not limited to the particular embodiments described below. The disclosure and description in the present document are illustrative and explanatory of one or more currently preferred embodiments and variations, and it will be clear to persons skilled in the art that various changes in the design, organization, order of operation, operating means, structures of the equipment and position, methodology and use of mechanical equivalents can be made without departing from the spirit of the invention.

Furthermore, it should be understood that the attached figures and drawings have the purpose of clearly illustrating and disclosing currently preferred embodiments to persons skilled in the art, but they are not drawings that illustrate how these embodiments should be executed in reality or real representations of end products; on the contrary, these figures can comprise simplified conceptual views to facilitate understanding or provide an easier and quicker explanation. Furthermore, the relative dimensions and arrangement of the components can differ from those shown and still function in the spirit of the invention.

Moreover, it should be understood that various directions like “upper”, “lower”, “left”, “right”, “front”, “rear” and so on are executed only with respect to the explanation in combination with the drawings and that the components can be oriented differently, for example during transport and production, and during operation. Since many different and distinct embodiments can be devised in the ambit of the concepts taught herein, and since multiple modifications can be made to the embodiments described herein, it should be understood that the details provided below must be interpreted as illustrative and non-limiting with respect to the spirit of the invention.

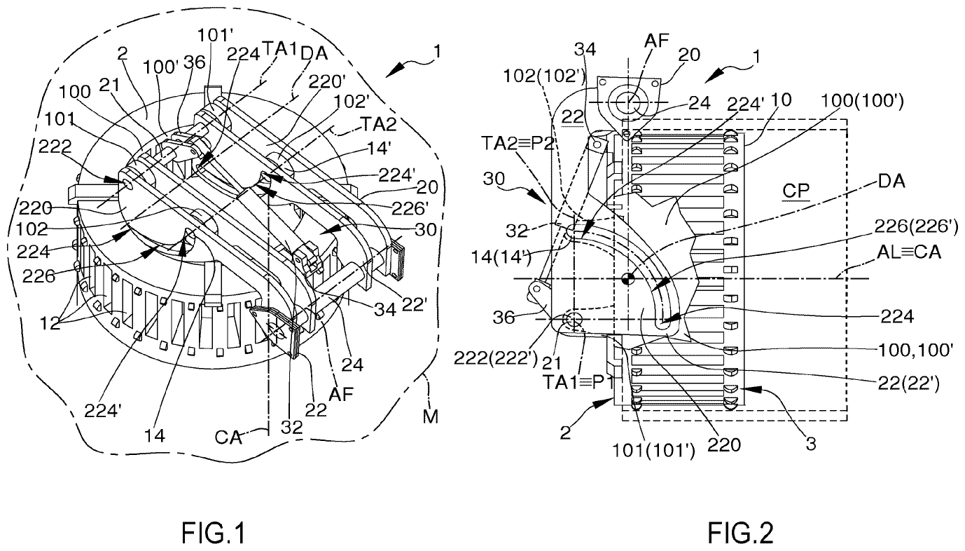

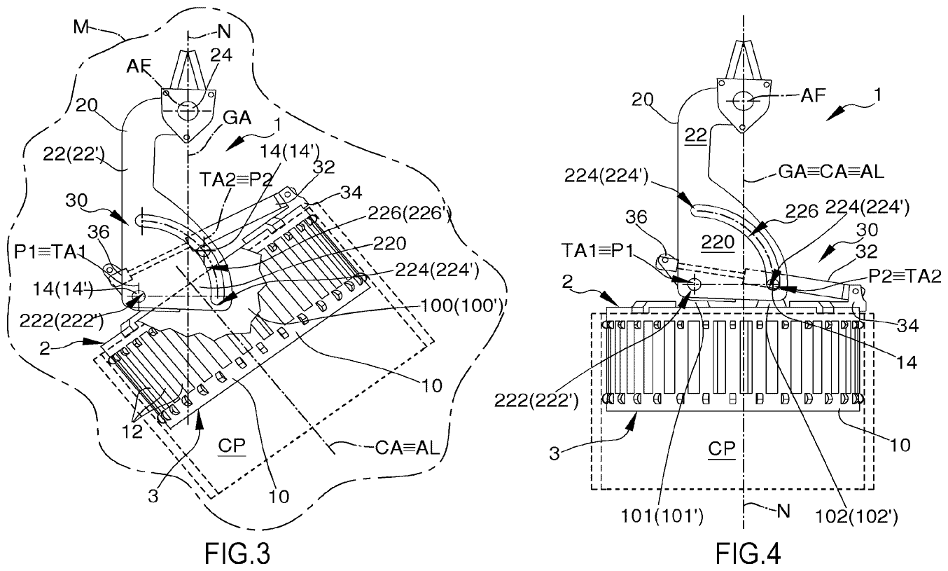

In FIG. 1, the number 1 indicates overall a gripping assembly 1 designed to grasp in an end position cylindrical piles CP provided with a longitudinal axis AL. The assembly 1 comprises a first cylindrical body 10 delimited by a first upper flat face 2 and by a second lower flat face 3 parallel to each other, of which only the lines that transversally cut a central axis CA of said first body 10 can be seen in the attached figures. Said first body 10 is provided with a plurality of gripping members 12 which are evenly distributed around the central axis CA and are radially movable to couple with one of the piles CP by friction, visible in FIGS. 2-4 where it is represented by a broken line to show the overall dimensions thereof. The gripping members 12 are of a known type and comprise wedges that can be operated by linear actuators. They are not described in further detail for the sake of economy of text and figures, since they are not important for understanding the invention.

The assembly 1 further comprises a lifting arm 20 in the shape of a fork and, therefore, having two lateral portions 22 and 22′ arranged symmetrically with respect to a longitudinal diametral plane M of the first body 10, where the line of this plane can be seen only in FIG. 1. The two lateral portions 22 and 22′ are hinge-connected to the first body 10 around a first axis TA1 transversal to the plane M in respective plates 100 and 100′ and arranged above the first face 2, therefore on the side opposite to said first face 2 with respect to the second face 3. These plates 100 and 100′, without limiting the scope of the present invention, are internal and arranged symmetrically with respect to the diametral plane M. In particular, the two lateral portions 22 and 22′ are also symmetrical with respect to the diametral plane M, and are fitted on an axle 21, which is concentric to the first axis TA1. Again, with reference to FIG. 1, the lateral portions 22 and 22′ are connected at the top by a central axle 24 which develops around a fulcrum axis AF parallel to the first axis TA1 and pre-arranged to be gripped in a rotatable manner, in turn, by a gripping member of a crane, known and not illustrated for the sake of economy of drawing.

Given the symmetry of the assembly 1, the text and/or the figures could present only one of the symmetrical components of the arm 20, for example, relative to only one of the lateral portions 22 and 22′, to the benefit of clarity of the figures and without entailing limitations to the scope of the present invention.

With particular reference to FIGS. 1 and 2, each lateral portion 22/22′ has an elbow 220/220′ rotoidally coupled to a rectangular plate 100/100′ integral with the first body 10 around the first axis TA1 through a first hooking member 222/222′, formed of a rotoidal pair, concentric to the first axis TA1, which comprises a bracket 101/101′ carried at the top by the plate 100/100′, an angle portion of the elbow 220/220′, where the bracket 101/101′ and the angle portion of the elbow 220/220′ are connected by the axle 21. As can be seen at the top in FIG. 1, each plate 100/100′ has a bracket 102/102′ which is arranged symmetrically with respect to the central axis CA of the same first body 10 and the shape of which is shown entirely by a broken line only in FIG. 2. Each bracket 102/102′ houses a second hooking member 14/14′, where each second hooking member 14/14′ is a pin, without limiting the generality of the invention. The two pins 14 and 14′ are aligned along a second axis TA2 which is parallel to the first axis TA1.

With particular reference to FIGS. 2-4, each elbow 220/220′ is shaped similarly to a triangle with convex hypotenuse and each pin 14/14′ is coupled to the elbow 220/220′ in an angularly sliding manner through a respective circular slot 226/226′ with size less than or equal to 90° and concentric to the first axis TA1 and delimited by two concave abutment portions 224 and 224′. With particular reference to FIG. 3, a first projection P1 of a centre of the rotoidal pair 222/222′ on the diametral plane M and a second projection P2 of a centre of the pin 14/14′ on the diametral plane M define a segment P1-P2, the geometric axis GA of which is perpendicular to and equidistant from the ends of the same segment P1-P2 and intersects the fulcrum axis AF.

With reference to any one of the attached figures, the assembly 1 comprises actuation members 30 arranged between the arm 20 and the first body 10 to move them with a relative rotary motion around the first axis TA1. In particular, the actuation members 30 comprise a linear actuator 32, the axis of which is transversal to the first axis TA1 and is carried at the ends by a first bracket 34 coupled to the first body 10 and by a second bracket 36 coupled to the arm 20 in an angularly fixed manner, since it is fitted on the axle 21.

The use of the assembly 1 can be easily understood from the above description and does not require further explanation. On the other hand, it may be useful to specify that each assembly consisting of elbow 220/220′, slot 226/226′ and pin 14/14′ defines a cam-tappet mechanism where the slot 226/226′ is the cam and the tappet is formed of the pin 14/14′, and the unit that determines the movement of the tappet with respect to the cam is the actuator 32.

Furthermore, it should be observed that, in use, when the assembly 1 is arranged as in FIG. 4, the linear actuator 32 is at maximum extension and the first body 10 is supported symmetrically by the pin 21 of the rotoidal pair 222/220′ and by the pin 14/14′ that engages the slit 226 with respect to a longitudinal plane N transversal to the diametral plane M, the line of which coincides with the lines of the geometric axis GA, central axis CA and longitudinal axis AL. In particular, in this case the fulcrum axis AF of the central axle 24 and the centres of the pins 14 and of the rotoidal pairs 222 are arranged at the vertexes of an isosceles triangle symmetrical with respect to the longitudinal plane N, where the isosceles triangle AF-P1-P2 has as its base the segment P1-P2. In this case, the stress on the plate 100/100′ is spread over the brackets 102/102′, optimizing distribution of the masses on the first body 10 and maximizing the stability of the first body 10 and the pile CP coupled to it with respect to the axle 24 and, naturally, to the crane, thus lightening the load on the linear actuator 32 in the case of oscillations of the pile CP itself. It is easy to understand that once the assembly 1 has been arranged with the arm 20 and the lateral portions 22 and 22′ as in the position of FIG. 4, any deactivation of the linear actuator 32 would not change the relative position between the arm 20 and the first body 10. Any rotations of the unit can occur only with respect to the fulcrum axis AF of the central axle 24, since the mass of the unit of the first body 10, and of the relative pile CP gripped, would be spread between the axle 21 and the pins 14/14′, therefore carried by the arm 20 in a manner always centred on the fulcrum axis AF of the central axle 24, thus avoiding the double pendulum effect in the conditions of “floating arm” described above in the prior art discussion. No impact can occur between the arm 20 and the first body 10 when the latter carries the respective pile CP aligned with its central axis CA since in this operating condition the arm 20 is totally external to the first body 10 due to the particular nature of the coupling between these two components of the gripping assembly 1. Lastly it is clear that modifications and variations can be made to the gripping assembly 1 described and illustrated herein without thereby departing from the scope of the present invention.

For example, the embodiment of the assembly 1 described above is functionally equivalent to a further embodiment in which the plates 100 and 100′ are entirely contained within the first body 10, so that the respective brackets 102 and 102′ are also contained within the longitudinal extension of the first body 10, without this modifying or limiting the scope of the present invention. In this case, not illustrated for the sake of economy of drawing, the first axis TA1 would be internal to the first body 10. Moreover, the scope of the present invention also includes a variation of the gripping assembly 1 in which the first body 10 is supported by a lifting arm 20 which has one single support portion 22, also arranged symmetrically with respect to the diametral plane M. The support portion 22 is hinge-connected to the first body 10 around a first axis TA1 in a respective plate 100, arranged centrally for the first body 10.

Furthermore, the scope of the present invention comprises a further variation of the assembly 1 in which the arm 20 has a portion that houses the axle 24 having dimensions different (larger or smaller) from those shown in the attached figures so that, when the first body 10 is arranged with the longitudinal axis AL vertical, the geometric axis GA of the segment P1-P2 is parallel to the central axis CA of the first cylindrical body 10 but the fulcrum axis AF of the central axle 24 is transversal and skewed with respect to the geometric axis GA.

In the claims, any reference sign in brackets must not be interpreted as a limitation of the claim. The word “comprising” does not exclude the presence of other elements or steps in addition to those listed in a claim. Furthermore, the term “one”, as used in this context, is defined as one or more than one. Furthermore, the use of introductory phrases like “at least one” and “one or more” in the claims must not be interpreted in the sense that the introduction of another claim element by the indefinite articles “a” or “an” limits any particular claim containing this claim element introduced to the inventions that contain only one, even when the same claim comprises introductory phrases like “one or more” or “at least one” and indefinite articles like “one” or “an”. The same applies to the use of definite articles. Unless established otherwise, terms such as “first” and “second” are used to arbitrarily distinguish the elements which these terms describe. Therefore, these terms are not necessarily designed to indicate the chronological or any other priority of said elements. The simple fact that some measures are described in different claims does not mean that a combination of these measures cannot be used to advantage.

1. A gripping assembly (1) designed to grasp cylindrical piles (CP) provided with a longitudinal axis (AL) in an end position; said assembly (1) comprising a first cylindrical body (10) provided with a central axis (CA) and with a plurality of gripping members (12) evenly distributed around said central axis (CA) and radially movable to couple with one of said piles (CP) by friction and delimited by a first upper flat face (2) and by a second lower flat face (3), parallel to each other and transversal to said central axis (CA) of the same first body (10); a lifting arm (20) comprising at least one support portion (22) arranged laterally with respect to a longitudinal diametral plane (M) and carried by said first body (10) hinged to a plate (100)(100′) integral with said first body (10) around a first axis (TA1) transversal to said diametral plane; each said support portion (22)(22′) being provided with a central axle (24) developed around a fulcrum axis (AF) parallel to said first axis (TA1) for supporting said arm (20) in a rotatable manner; characterised in that said first axis (TA1) is arranged on the outside of said first body (10) on the side opposite to said second face (3) with respect to said first face (2).

2. The assembly according to claim 1, characterised in that each said support portion (22)(22′) has an elbow (220)(220′) rotoidally coupled to the corresponding said plate (100)(100′) around said first axis (TA1) by a first hooking member (222)(222′); each said plate (100)(100′) having a second hooking member (14)(14′) coupled with said elbow (220)(220′) so as to angularly slide through a respective circular slit (226)(226′) concentric with said first axis (TA1) and delimited by two concave abutment portions (224)(224′).

3. The device according to claim 2, characterised in that said lifting arm (20) comprises two support portions (22)(22′) each hinged to a respective said plate (100)(100′) around said first axis (TA1), said support portions (22)(22′) being arranged symmetrically with respect to said diametral plane (M); said support portions (22)(22′) being connected by said central axle (24).

4. The assembly according to claim 2 or 3, characterised in that a first projection (P1) of a centre of said first hooking member (222)(222′) over said diametral plane (M) and a second projection (P2) of a centre of said second hooking member (14)(14′) over said diametral plane (M) define a segment (P1-P2) a geometric axis (GA) of which is parallel to or coincides with said central axis (CA).

5. The assembly according to claim 4, characterised in that said two concave abutment portions (224)(224′) are spaced from one another by an angle of less than 90° centred on said first axis (TA1).

6. The assembly according to claim 1, further comprising actuation means (30) arranged between said arm and said first body to move them with a relative rotary motion around said first axis (TA1).

7. The assembly according to claim 6, characterised in that said actuation means (30) comprise a linear actuator (32) the axis of which is transversal to said first axis (TA1) and is carried at the ends by a first bracket (34) coupled to said first body (10) and by a second bracket (36) coupled to said arm (20) in an angularly fixed manner.

8. The assembly according to claim 3, characterised in that each said second hooking member (14)(14′) comprises a pin (14)(14′) carried by a bracket (102)(102′) of said plate (100)(100′).

9. The assembly according to claim 2, characterised in that said first hooking member (222)(222′) comprises a rotoidal pair.

10. The assembly according to claim 1, characterised in that said first axis (TA1) is external or internal to said first body (10).

11. The assembly according to claim 3, characterised in that a first projection (P1) of a centre of said first hooking member (222)(222′) over said diametral plane (M) and a second projection (P2) of a centre of said second hooking member (14)(14′) over said diametral plane (M) define a segment (P1-P2) a geometric axis (GA) of which is parallel to or coincides with said central axis (CA).

12. The assembly according to claim 2, further actuation means (30) arranged between said arm and said first body to move them with a relative rotary motion around said first axis (TA1).

13. The assembly according to claim 4, further actuation means (30) arranged between said arm and said first body to move them with a relative rotary motion around said first axis (TA1).

14. The assembly according to claim 7, characterised in that each said second hooking member (14)(14′) comprises a pin (14)(14′) carried by a bracket (102)(102′) of said plate (100)(100′).

15. The assembly according to claim 5, characterised in that each said second hooking member (14)(14′) comprises a pin (14)(14′) carried by a bracket (102)(102′) of said plate (100)(100′).

16. The assembly according to claim 3, characterised in that said first hooking member (222)(222′) comprises a rotoidal pair.

17. The assembly according to claim 5, characterised in that said first hooking member (222)(222′) comprises a rotoidal pair.

18. The assembly according to claim 2, characterised in that said first axis (TA1) is external or internal to said first body (10).

19. The assembly according to claim 5, characterised in that said first axis (TA1) is external or internal to said first body (10).

20. The assembly according to claim 7, characterised in that said first axis (TA1) is external or internal to said first body (10).
